(19) United States
(12) Patent Application Publication
(10) Pub. No.: US 2024/0377591 A1
(43) Pub. Date: Nov. 14, 2024

(54) CONVERTERS FOR FIBER OPTIC CONNECTORS

(71) Applicant: CommScope Technologies LLC, Hickory, NC (US)

(72) Inventors: Danny Willy August VERHEYDEN, Gelrode (BE); Yu LU, Eden Prairie, MN (US); Michael Lawrence GURRERI, York, PA (US); Petr KRŠKA, Bucovice (CZ)

(73) Assignee: CommScope Technologies LLC, Hickory, NC (US)

(21) Appl. No.: 18/692,684

(22) PCT Filed: Sep. 15, 2022
(86) PCT No.: PCT/US2022/043653

§ 371 Date: Mar. 15, 2024

Related U.S. Application Data
(60) Provisional application No. 63/245,357, filed on Sep. 17, 2021.

(51) Int. Cl. G02B 6/38

(52) U.S. Cl. CPC G02B 6/3825; G02B 6/3849; G02B 6/387; G02B 6/3871; G02B 6/3874

(57) ABSTRACT

The present disclosure relates to converters for converting a male fiber optic connector to a female fiber optic connector. The converters can include configurations that are environmentally sealed and ruggedized.

This application is being filed on Sep. 15, 2022 as a PCT International Patent Application and claims the benefit of U.S. Patent Application Ser. No. 63/245,357, filed on Sep. 17, 2021, the disclosure of which is incorporated herein by reference in its entirety.

### TECHNICAL FIELD

The present disclosure relates generally to fiber optic connectors. More particularly, the present disclosure relates to converter systems for fiber optic connectors.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Example ruggedized fiber optic connection systems are disclosed by U.S. Pat. Nos. 7,467,896; 7,744,288 and 8,556,520.

It will be appreciated that a number of different types of ruggedized fiber optic connectors are available for outside environmental use. International Publication No. WO2015/028433 discloses a system for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter.

### SUMMARY

One aspect of the present disclosure relates to a converter for converting a fiber optic connector from a first form factor to a second form factor. In one example, the converter is configured for converting a male fiber optic connector to a female fiber optic connector. In one example, the converter has a ruggedized and sealed configuration and is adapted for providing optical connections rated for outdoor use.

Another aspect of the present disclosure relates to a converter for converting a first male fiber optic connector to a female fiber optic connector. The converter includes a converter housing having a length that extends along a central axis of the converter housing between first and second opposite ends of the converter housing. The converter housing defines a first connector port at the first end of the converter housing and a second connector port at the second end of the converter housing. The first connector port is smaller than the second connector port and is configured to receive the first male fiber optic connector. The second connector port is configured to receive a second male fiber optic connector desired to be optically coupled to the first male fiber optic connector via the converter. The converter also includes a ferrule alignment sleeve positioned within the converter housing along the central axis for aligning ferrules of the first and second male fiber optic connectors. The ferrule alignment sleeve is positioned closer to the second end of the converter housing than the first end of the converter housing. In one example, turn-to-secure connection arrangements are provided at the first and second connector ports for securing the first and second male fiber optic connectors within their respective ports. In one example, the converter is configured such that the first and second male fiber optic connectors are sealed with respect to the converter housing when installed within their respective first and second connector ports.

Another aspect of the present disclosure relates to a converter for converting a first male fiber optic connector to a female fiber optic connector. The converter includes a converter housing having a length that extends along a central axis of the converter housing between first and second opposite ends of the converter housing. The converter housing defines a first connector port at the first end of the converter housing and a second connector port at the second end of the converter housing. The first connector port is configured to receive the first male fiber optic connector. The second connector port is configured to receive a second male fiber optic connector desired to be optically coupled to the first male fiber optic connector via the converter. The converter also includes a ferrule alignment sleeve positioned within the converter housing along the central axis for aligning ferrules of the first and second male fiber optic connectors. The converter is configured such that once the first male fiber optic connector is installed within the first connector port, the converter is required to be broken to remove the first male fiber optic connector from the first connector port. In contrast, the second male fiber optic connector can be removed from the second connector port without requiring the converter to be broken. In one example, the first male fiber optic connector is latched in an interlocked position with respect to the converter housing and access to the latch is blocked by a sleeve. In one example, the sleeve is required to be broken to remove the sleeve from the converter housing thereby allowing the first male fiber optic connector to be removed from the first connector port. In one example, the latch for retaining the first male fiber optic connector in the interlocked position with respect to the converter housing is unitary formed with the sleeve. In one example, the first male fiber optic connector is secured to the converter housing by a turn-to-secure coupler that is turned to interlock with the converter housing and that is latched in the interlock position by the latch integrated with the sleeve.

Another aspect of the present disclosure relates to a fiber optic device including a fiber optic connection device and a lateral coupler that mounts on the fiber optic connection device. The lateral coupler is configured for coupling a plurality of the fiber optic connection devices together in a group with central axes of the fiber optic connection devices parallel to one another. It will be appreciated that lateral couplers of adjacent ones of the fiber optic connection devices in the group interconnect with one another to provide lateral coupling between the fiber optic connection devices of the group.

A further aspect of the present disclosure relates to a converter for coupling a male fiber optic connector to another optical component. In certain examples, the other optical component can include another male fiber optic connector, a connector port such as a port defined by a fiber-optic adapter or a female fiber optic connector, or other component. The converter includes a converter housing having a length that extends along a central axis of the converter housing between first and second opposite ends of the converter housing. The converter housing defines a first connector port at the first end of the converter housing which is configured to receive the male fiber optic connector. The converter also includes a first sealing element having a resilient construction adapted to be press fit within the first connector port when the male fiber optic connector is not inserted into the first connector port to prevent contamination from entering the converter housing through the first connector port. The converter also includes a second sealing element attached to the converter housing by a lanyard and adapted to be secured at the second end of the converter housing by a turn-to-secure connection when the second end of the converter housing is not mated with the optical component to prevent contamination from entering the converter housing through the second end of the converter housing.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 depicts an optical connection system in accordance with the principles of the present disclosure;

FIG. 2 depicts the optical connection system of FIG. 1 shown coupled together;

FIG. 3 is a longitudinal cross-sectional view through the optical connection system of FIG. 2;

FIG. 3A is an enlargement of a portion of FIG. 3;

FIG. 4 is an assembled converter of the optical connection system of FIG. 1;

FIG. 5 is an exploded view of the converter of FIG. 4;

FIG. 6 is a longitudinal cross-sectional view of a converter housing of the converter of FIGS. 4 and 5;

FIG. 7 is a longitudinal cross-sectional view of the converter of FIGS. 4 and 5;

FIG. 8 is another longitudinal cross-sectional view of a converter housing of the converter of FIGS. 4 and 5 taken along a cross-section plane perpendicular to the cross-section plane of FIG. 6;

FIG. 9 is a perspective view of the converter housing of FIGS. 6 and 8;

FIG. 10 is an enlarged view of an end of the converter housing of FIG. 9;

FIG. 11 is an end view of the converter of FIGS. 4 and 5 with the dust plug removed;

FIG. 12 is an opposite end view of the converter of FIGS. 4 and 5 with the dust plug removed;

FIG. 13 is a perspective view of the end of the converter of FIG. 12;

FIG. 14 is a partial cross-section of the view of FIG. 13;

FIG. 15 shows the end of the converter of FIG. 12 with an outer sleeve removed;

FIG. 16 is a cross-sectional view showing a male connector inserted into the end of the converter of FIG. 12 depicting a rib-reinforced sealing region of the converter housing;

FIG. 17 depicts an alternative converter having a ferrule alignment sleeve holder secured within the converter housing by a snap-fit connection;

FIG. 18 depicts another converter having a ferrule alignment sleeve holder secured within the converter housing by a snap-fit connection and with the converter housing including an extended connector guide sleeve that extends beyond the ferrule alignment sleeve holder for guiding a fiber optic connector inserted into the converter such that a ferrule of the fiber optic connector is received into a ferrule alignment sleeve held by the ferrule alignment sleeve holder;

FIG. 19 is a longitudinal cross-sectional view of another converter in accordance with the principles of the present disclosure;

FIG. 20 is a perspective view of a further converter in accordance with the principles of the present disclosure;

FIG. 21 is a longitudinal cross-sectional view of the converter of FIG. 20;

FIG. 22 depicts the converter of FIGS. 4 and 5 in combination with a lateral coupler that mounts on the converter housing;

FIG. 23 depicts the lateral coupler of FIG. 22 mounted on the converter housing;

FIG. 24 is a perspective view showing a plurality of the converters grouped together via connections provided by lateral couplers mounted on the converters;

FIG. 25 is an end view of the group of FIG. 24;

FIG. 26 depicts the converter of FIGS. 4 and 5 in combination with another lateral coupler that mounts on the converter housing;

FIG. 27 depicts the lateral coupler of FIG. 26 mounted on the converter housing;

FIG. 28 depicts a plurality of the converters grouped together in a row via connections provided by lateral couplers of the type shown at FIGS. 26 and 27 mounted on the converters;

FIG. 29 is a cross-sectional view depicting a mechanical connection interface provided between two of the lateral couplers of FIGS. 27 and 28 which are being used to secure two of the converter housings together;

FIG. 30 depicts still another lateral coupler in accordance with the principles of the present disclosure shown mounted on a converter;

FIG. 31 is a perspective view of the lateral coupler of FIG. 30;

FIG. 32 is a side view of the lateral coupler of FIG. 30;

FIG. 33 is a first end view of the lateral coupler of FIG. 30;

FIG. 34 is a second end view of the lateral coupler of FIG. 30;

FIG. 35 shows a plurality of the converters coupled together in a row via lateral couplers of the type shown at FIGS. 30-34; and

FIG. 36 shows a plurality of the converters coupled together in a triangular grouping via lateral couplers of the type shown at FIGS. 30-34.

### DETAILED DESCRIPTION

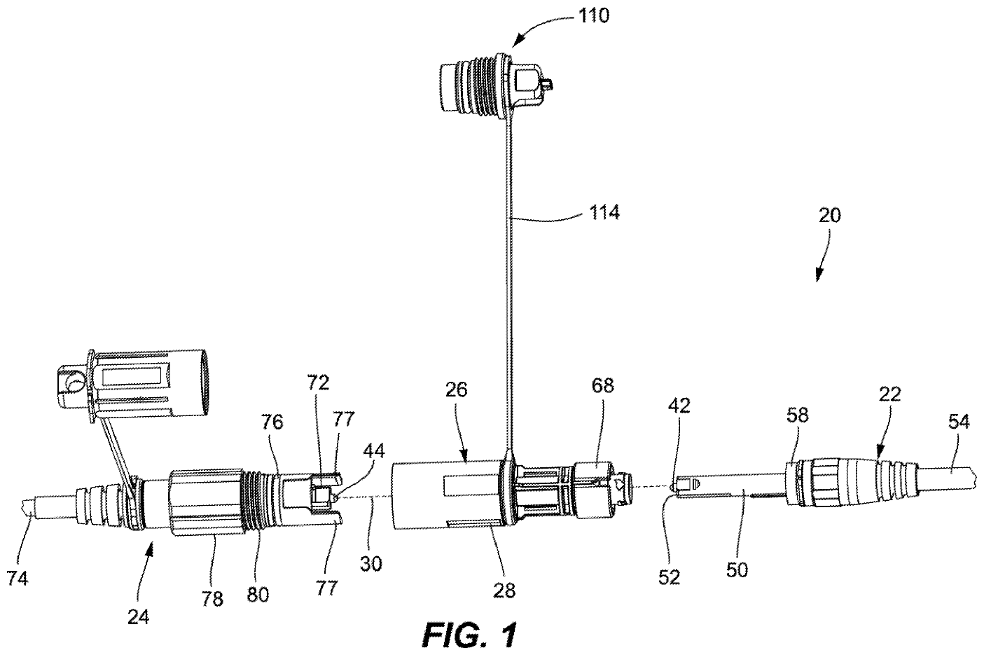

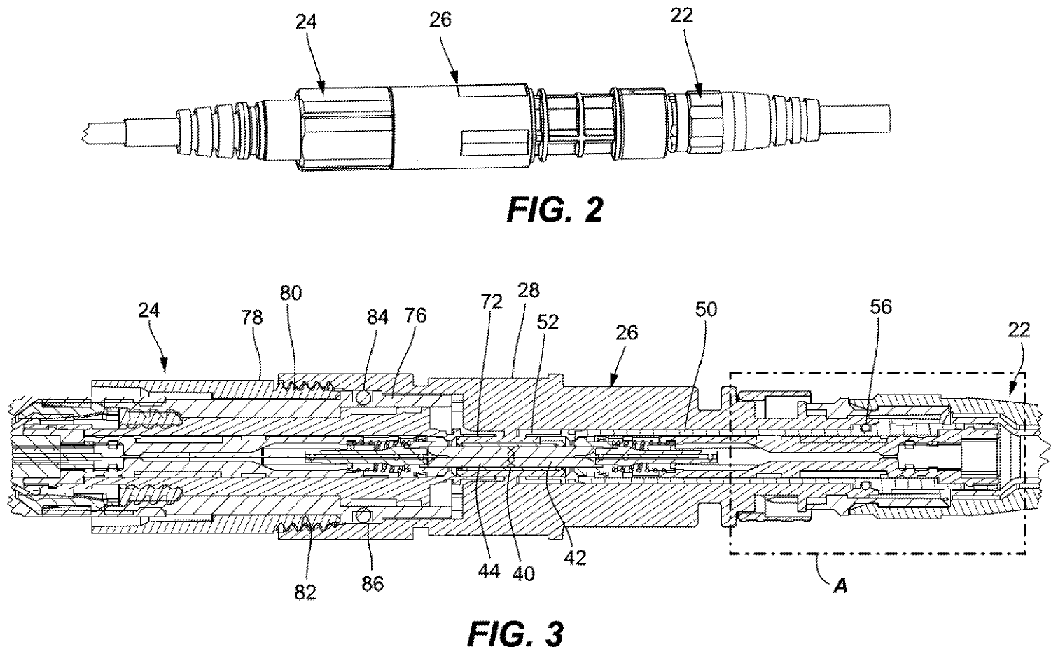

FIGS. 1 and 2 depict a fiber-optic connection system 20 in accordance with the principles of the present disclosure. The fiber-optic connection system 20 includes a first male fiber optic connector 22, a second male fiber optic connector 24 and a converter 26. The converter 26 is adapted to convert the first male fiber optic connector 22 into a female fiber optic connector suitable for receiving the second male fiber optic connector 24. In this way, the converter 26 allows the first male fiber optic connector 22 to be optically and mechanically coupled to the second male fiber optic connector 24.

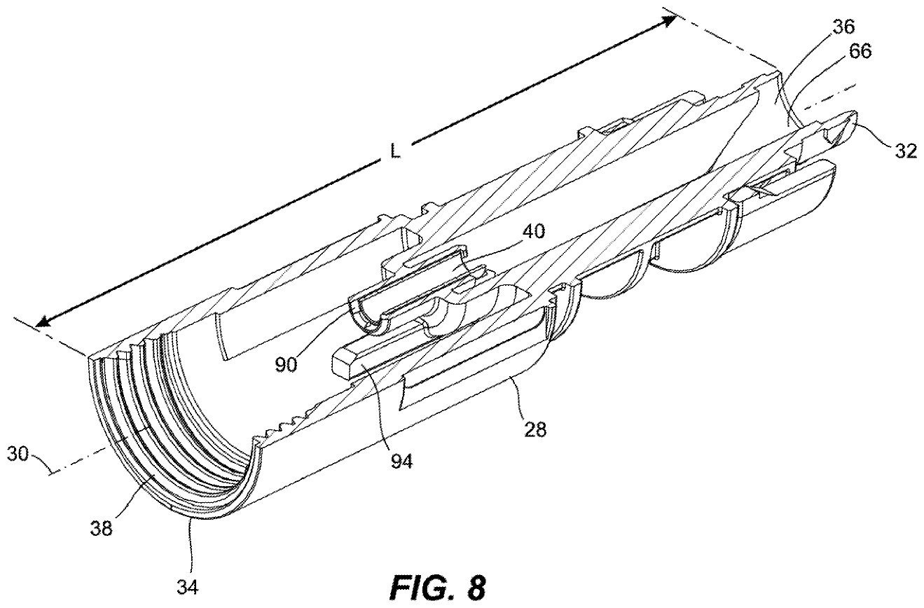

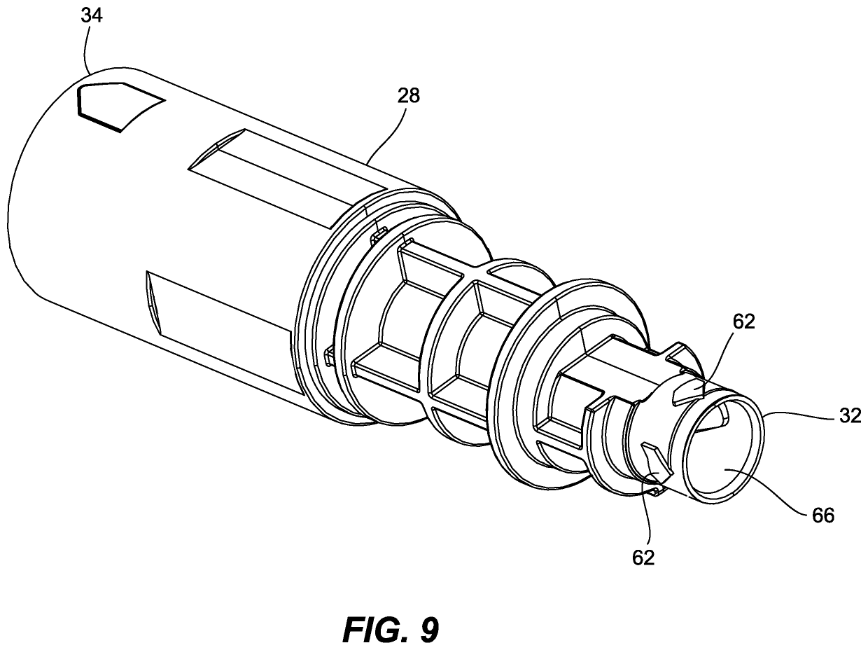

The converter 26 includes a converter housing 28 having a length L (see FIG. 8) that extends along a central axis 30 of the converter housing 28 between first and second opposite ends 32, 34 of the converter housing 28. The converter housing 28 defines a first connector port 36 at the first end 32 of the converter housing 28 and a second connector port 38 at the second end 34 of the converter housing 28. In the depicted example, the first connector port 36 is smaller than the second connector port 38 and is configured to receive the first male fiber optic connector 22. The second connector port 38 is configured to receive the second male fiber optic connector 24. The converter 26 also includes a ferrule alignment sleeve 40 positioned within the converter housing 28 along the central axis 30 for aligning ferrules 42, 44 of the first and second male fiber optic connectors 22, 24 when the first and second male fiber optic connectors 22, 24 are secured within their respective first and second connector ports 36, 38. In the depicted example, the ferrule alignment sleeve 40 is positioned closer to the second end 34 of the converter housing 28 and the first end 32 of the converter housing 28.

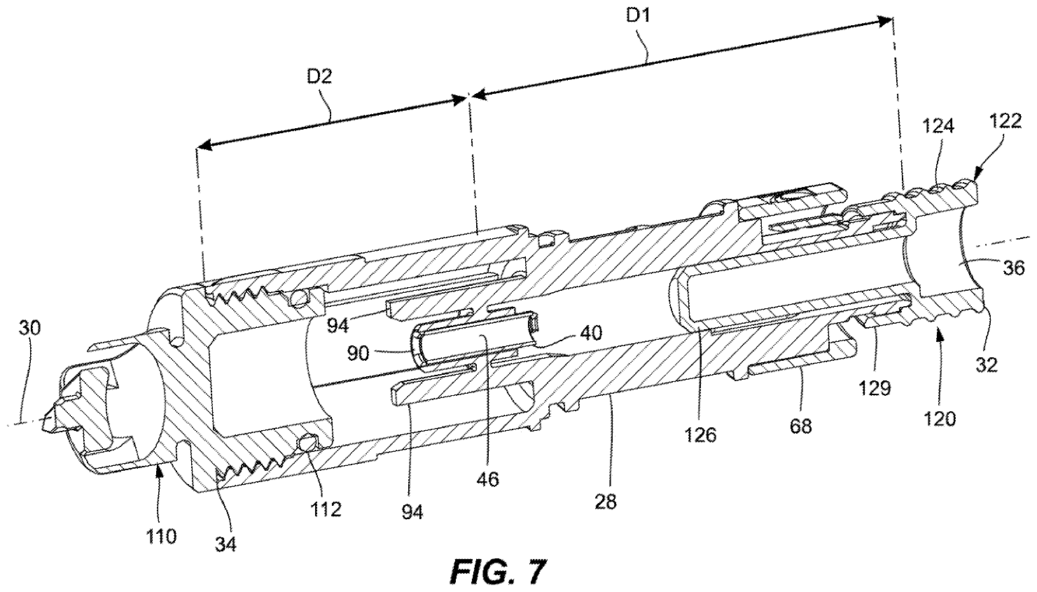

Referring to FIG. 7, the converter 26 defines a first distance D1 measured along the central axis 30 between the first end 32 of the converter housing 28 and a midpoint 46 of the ferrule alignment sleeve 40. The converter 26 also defines a second distance D2 measured along the central axis 30 between the second end 34 of the converter housing 28 and the midpoint 46 of the ferrule alignment sleeve 40. In certain examples, the first distance D1 is at least 10%, 20%, 30%, 40%, 50%, 60%, 70%, 80% or 90% longer than the second distance D2.

In one example, the ferrule alignment sleeve 40 has an elastic construction and can be configured as a split-sleeve. Example materials for manufacturing the ferrule alignment sleeve 40 include zirconia ceramic and phosphor bronze materials.

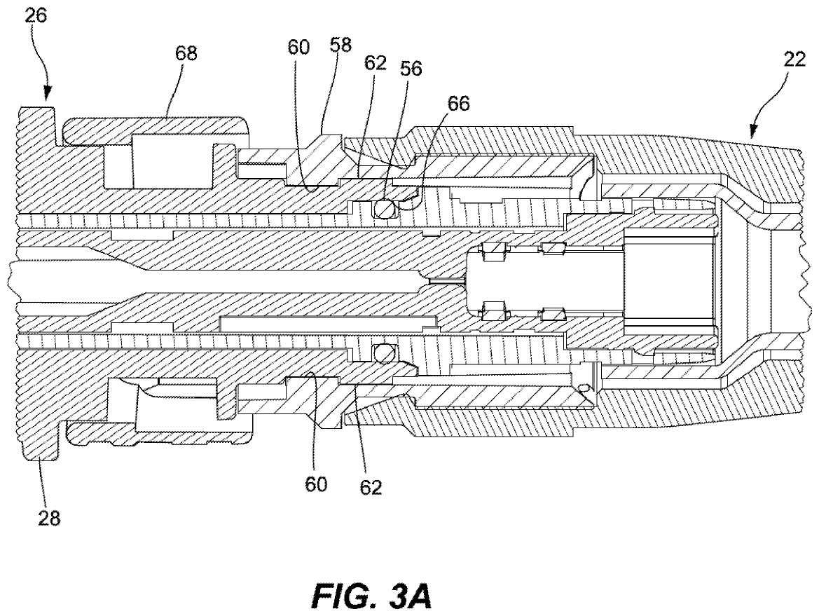

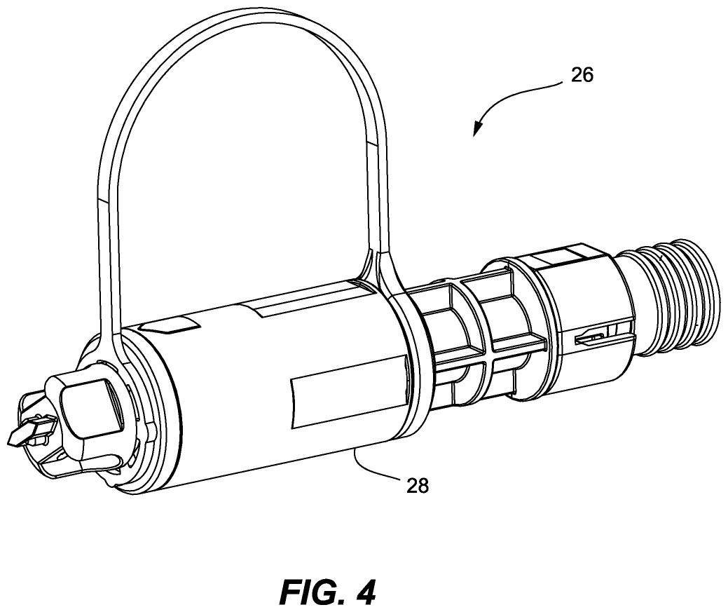

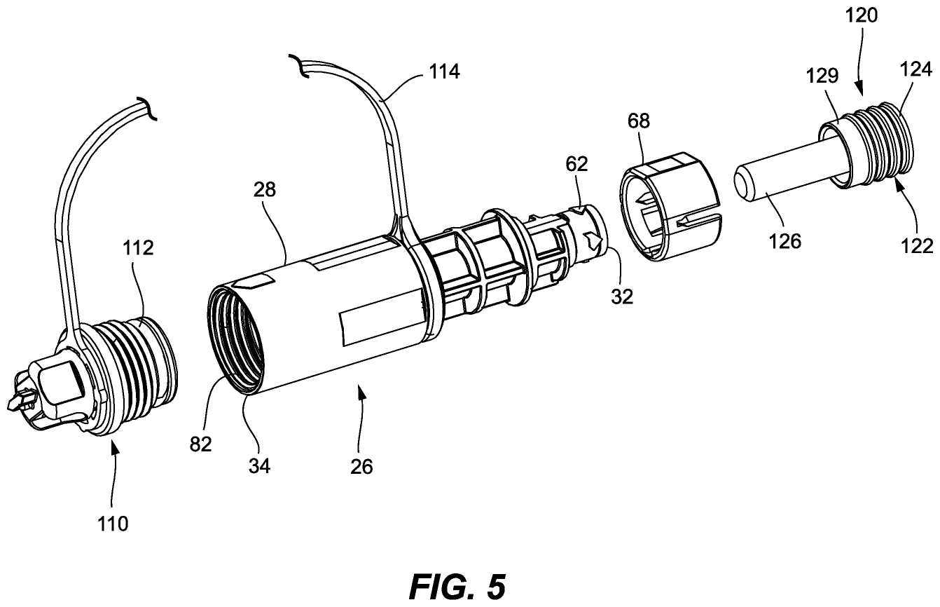

The first male fiber optic connector 22 includes an elongate connector body 50 having a distal end 52 at which the ferrule 42 is positioned. It will be appreciated that the ferrule 42 supports an optical fiber corresponding to a fiber-optic cable 54 to which the first male fiber optic connector 22 is secured. The first male fiber optic connector 22 includes a seal 56 (e.g., a radial seal such as an O-ring or other seal) mounted within a circumferential groove defined at an exterior of the elongate connector body 50. The first male fiber optic connector 22 also includes a turn-to-secure coupler 58 that can be turned relative to the elongate connector body 50 about a longitudinal axis of the connector body 50. In one example, the turn-to-secure coupler 58 is a quarter-turn coupler of the type described in PCT international publication numbers WO2020/236512 and WO2021/041305 which are hereby incorporated by reference in their entireties. The turn-to-secure coupler 58 includes internal interlock projections 60 (see FIG. 3A) circumferentially spaced relative to one another within the interior of the turn-to-secure coupler 58.

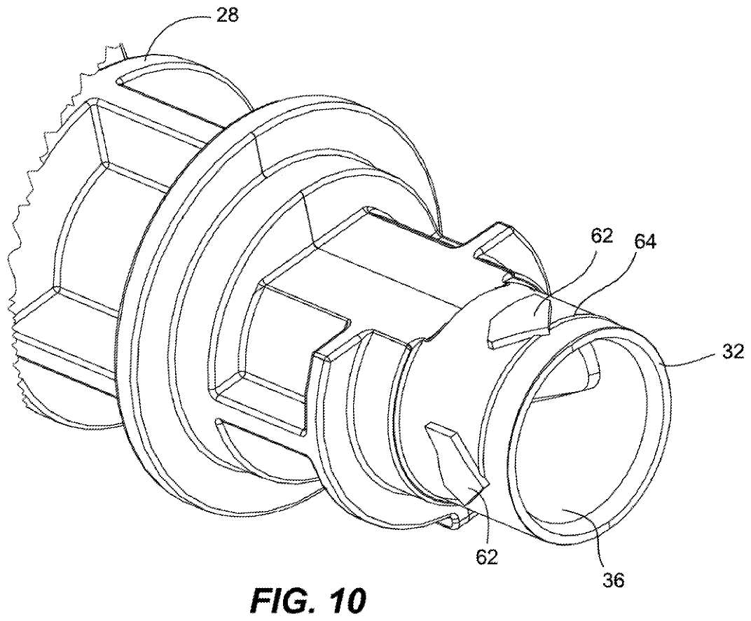

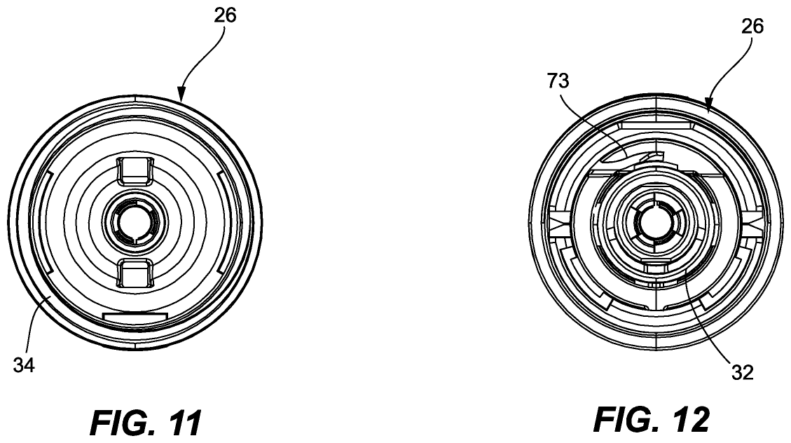

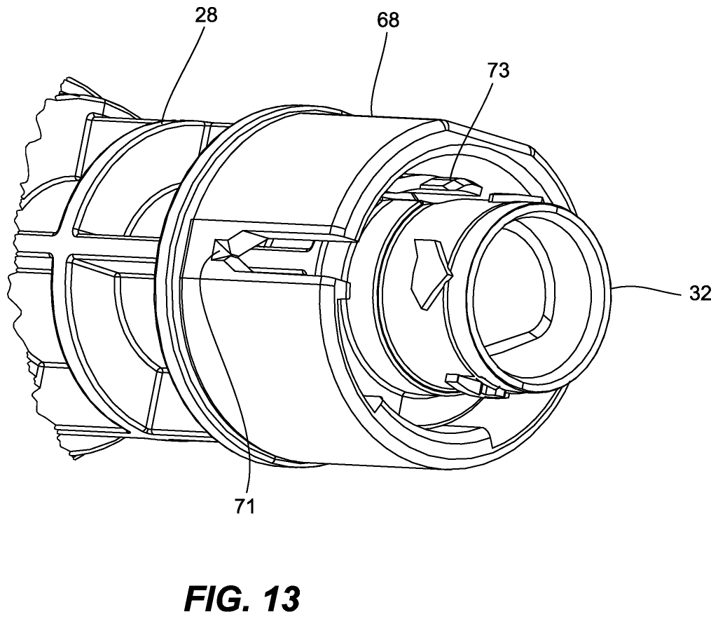

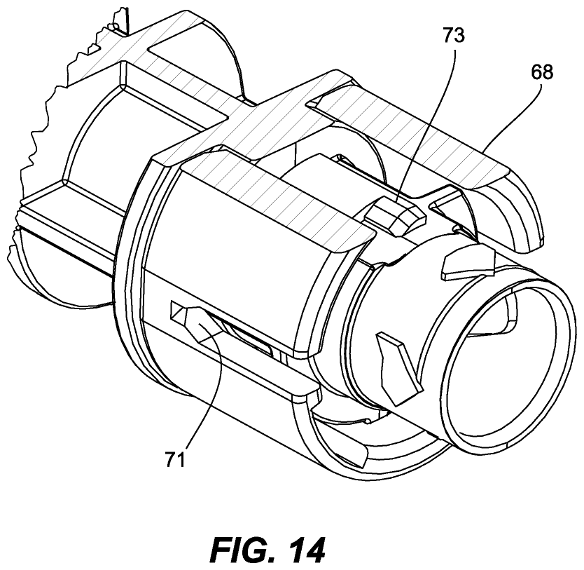

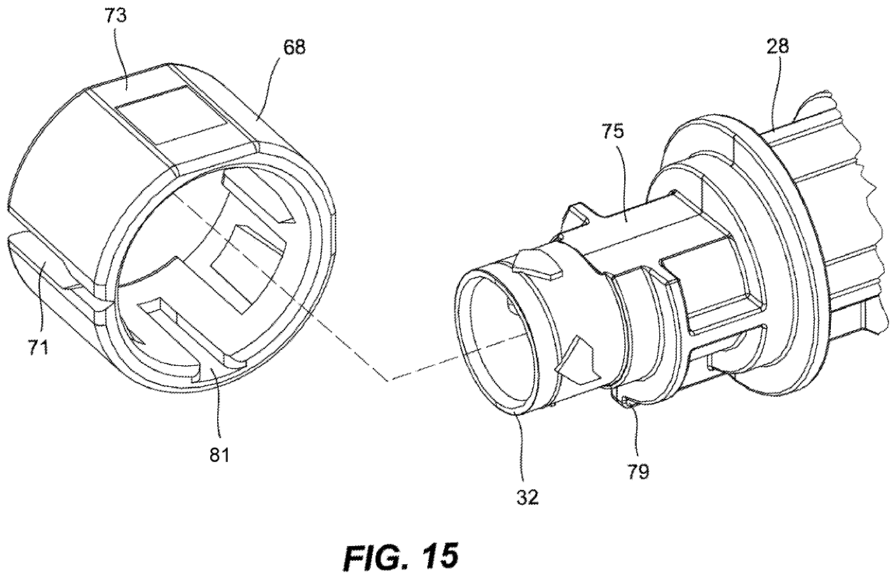

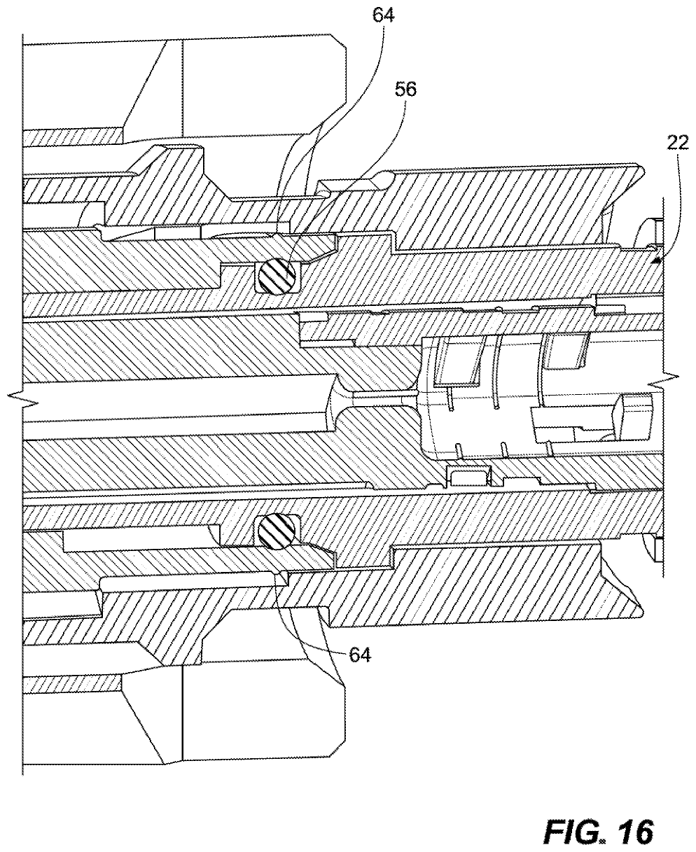

The converter housing 28 includes structure for enabling the first male fiber optic connector 22 to be mechanically coupled to the first end 32 of the converter housing 28 and to be sealed with respect to the converter housing 28 when the first male fiber optic connector 22 is installed within the first connector port 36. For example, the converter housing 28 can include a first interlock arrangement adapted to interlock with the turn-to-secure coupler 58 when the turn-to-secure coupler 58 is turned to an interlock position. When the turn-to-secure coupler 58 is interlocked with respect to the interlock arrangement of the converter housing 28, the first male fiber optic connector 22 is prevented from being axially withdrawn from the first connector port 36 by interference between the first interlock arrangement and the internal interlock projections 60 of the turn-to-secure coupler 58. In the depicted example, the first interlock arrangement includes outer interlock projections 62 spaced circumferentially about the central axis 30 and integrated with an outer side of the converter housing 28 adjacent the first end 32 of the converter housing 28. The converter housing 28 also includes an outer circumferential reinforcing rib 64 (see FIGS. 10 and 16) integrated with the outer side of the converter housing 28. The outer circumferential reinforcing rib 64 is positioned axially between the outer interlock projections 62 and the first end 32 of the converter housing 28. In the depicted example, the reinforcing rib 64 extends about the circumference of the converter housing 28 and surrounds an inner sealing surface 66 of the converter housing 28. It will be appreciated that the inner sealing surface 66 is adapted to engage the seal 56 of the first male fiber optic connector 22 when the first male fiber optic connector 22 is installed within the first connector port 36 to provide sealing between the first male fiber optic connector 22 and the converter housing 28. In the depicted example, the inner sealing surface 66 faces radially toward the central axis 30 and extends circumferentially around the central axis 30. When the seal 56 engages the inner sealing surface 66, the reinforcing rib 64 surrounding the inner sealing surface 66 reinforces the inner sealing surface 66 to inhibit outward deformation of the sealing surface during sealing.

The outer interlock projections 62 are adapted to interlock with the internal interlock projections 60 of the turn-to-secure coupler 58 of the first male fiber optic connector 22. The turn-to-secure coupler 58 is axially insertable over and axially removable from the first end 32 of the converter housing 28 without interference from the outer interlock projections 62 when the turn-to-secure coupler 58 is in a first rotational position. The internal interlock projections 60 of the coupler 58 are adapted to interfere with the outer interlock projections 62 when the coupler 58 is in a second rotational position such that axial movement between the coupler 58 and the first end 32 of the converter housing 28 is prevented. The coupler 58 is used to secure the first male fiber optic connector 22 to the first end 32 of the converter housing 28 by inserting the coupler 58 over the first end 32 of the converter housing 28 while the connector body 50 is inserted into the first connector port 36 and while the coupler 58 is in the first rotational position. Once the first male fiber optic connector 22 is fully inserted within the first connector port 36, the coupler 58 is turned about its central axis from the first rotational position to the second rotational position in which the outer interlock projections 62 interfere with the interlock projections 60 of the coupler 58 to prevent the coupler 58 and thus the first male fiber optic connector 22 from being axially removed from the first end 32 of the converter housing 28.

In certain examples, the converter 26 includes a latch that locks the coupler 58 in the second rotational position on the first end 32 of the converter housing 28. The converter 26 can include an outer sleeve 68 for covering the latch to block access to the latch such that the first male fiber optic connector 22 can only be removed from the first end 32 of the converter housing 28 by breaking the outer sleeve 68. The outer sleeve 68 can include predefined break locations 71 for facilitating breaking the outer sleeve 68 with a pry tool. In one example, a dust plug the converter 26 can have an integrated pry tool for facilitating breaking the outer sleeve 68.

In certain examples, the latch for latching the coupler 58 in the second rotational position (i.e., the connector securing position) can be integrated with the converter housing 28 and can be adapted to engage a catch provided on the coupler 58 for locking the coupler in the second rotational position. In such an example, by breaking the outer sleeve 68, the latch can be accessed and flexed to a release position that allows the coupler 58 to be moved from the second rotational position to the first rotational position to allow the first male fiber optic connector 22 to be axially removed from the first connector port 36 of the converter housing 28. In another example, the latch (e.g., latch 73) can be integrated with the interior of the outer sleeve 68 and can also be configured for engaging in the catch on the coupler 58 for locking the coupler and the second rotational position. In this example, the latch automatically disengages from the catch upon removing the outer sleeve 68 from the exterior of the converter housing 28. By integrating the latch with the outer sleeve 68, reuse of the converter housing 28 once the sleeve has been broken away from the converter housing 28 is discouraged since no latch is available for retaining the coupler 58 in the second rotational position.

In a preferred example, the elongate connector body 50 of the first male fiber optic connector 22 is keyed relative to the first connector port 36 to ensure that the first male fiber optic connector 22 is inserted into the first connector port 36 at the appropriate rotational position. In the case where the outer sleeve 68 includes the latch for locking the coupler 58 in the second rotational position, the outer sleeve 68 is preferably keyed relative to the first end 32 of the converter housing 28 to ensure the outer sleeve 68 is mounted at the appropriate rotational orientation such that the latch is suitably positioned for locking the coupler 58 and the second rotational position. In one example, the outer sleeve 68 can include a flat 75 that opposes a flat 75 of the first end 32 of the converter housing 28 and also includes an opposite slot 81 that receives a corresponding rail 79 integrated with the exterior of the converter housing 28 adjacent the first end 32.

The second male fiber optic connector 24 includes a connector body 72 having a distal end at which the ferrule 44 is supported. It will be appreciated that the ferrule 44 supports an optical fiber corresponding to a fiber-optic cable 74 to which the second male fiber optic connector 24 is terminated. The second male fiber optic connector 24 includes a shroud 76 positioned over the connector body 72. The shroud 76 includes paddles 77 for providing rotational keying with respect to the second connector port 38. In one example, the second connector port 38 of the converter housing 28 includes receivers corresponding to the paddle 77 such that the second male fiber optic connector 24 is only permitted to be inserted into the second connector port 38 in one rotational position. The second male fiber optic connector 24 further includes a turn-to-secure coupler 78 mounted on the shroud 76. The turn-to-secure coupler 78 is configured to be turned relative to the shroud 76 about a central axis of the second male fiber optic connector 24. In the depicted example, the turn-to-secure coupler 78 includes exterior threads 80 adapted to interlock with (e.g. thread within, mate with) corresponding inner threads 82 defined within the second connector port 38. The inner threads 82 can be referred to as interlocks or as an interlock arrangement. The second male fiber optic connector 24 further includes a circumferential seal 84 mounted on the shroud 76. The seal 84 is depicted as a radial seal mounted within a circumferential groove defined at an exterior of the shroud 76. When the second male fiber optic connector 24 is inserted into the second connector port 38, the ferrule 44 is received within the ferrule alignment sleeve 40, the seal 84 seals against an inner circumferential sealing surface 86 defined within the second connector port 38 to provide sealing between the second male fiber optic connector 24 and the converter housing 28, and the exterior threads 80 of the turn-to-secure coupler 78 can be threaded into the inner threads 82 of the second connector port 38 to axially retain the second male fiber optic connector 24 within the second connector port 38. The sealing surface 86 faces radially toward the central axis 30 and circumferentially surrounds the central axis 30. It will be appreciated that the second male fiber optic connector 24 can be removed from the second connector port 38 by unthreading the turn-to-secure coupler 78 from the inner threads 82 of the second connector port 38. When the first and second male fiber optic connectors 22, 24 are installed within the converter 26, the ferrules 42, 44 are aligned with respect to one another within the ferrule alignment sleeve 40 such that an optical connection is made between the optical fibers carried by the first and second male fiber optic connectors 22, 24.

In the depicted examples, the first and second connector ports 36, 38 include inner sealing surfaces for engaging seals provided on the fiber optic connectors 22, 24. In other examples to accommodate different connectors, the sealing surfaces may be provided on the exterior of the converter housing 28 surrounding the ports. In still other examples, the ports may include seals (e.g. face seals, radial seals, or other seals) provided either inside or outside the first and second connector ports 36, 38 for providing sealing with respect to corresponding fiber optic connectors inserted therein. In the depicted example, the first end of the converter housing 28 includes an interlock arrangement including a plurality of interlock projections positioned circumferentially about an exterior of the converter housing 28. In other examples, circumferentially spaced interlock projections can be provided inside the first connector port. In still other examples, an interlock structure such as a bayonet feature or threads can be provided either inside the first connector port or around the exterior of the converter housing at the first end of the converter housing. Similarly, in alternative examples, the second end 34 of the converter housing 28 can include alternative interlock structures for securing connectors within the second port. For example, the alternative interlock structures can include threads at an exterior of the converter housing 28, interlock projections provided either on the exterior of the converter housing 28 or within the second connector port 38, or bayonet features provided either within the second connector port 38 or at an exterior of the converter housing 28 adjacent the second end 34. In still other examples, the first connector port 36 and/or the second connector port 38 can be configured to secure connectors therein by latches such as flexible latches, slidable latches or other types of latches.

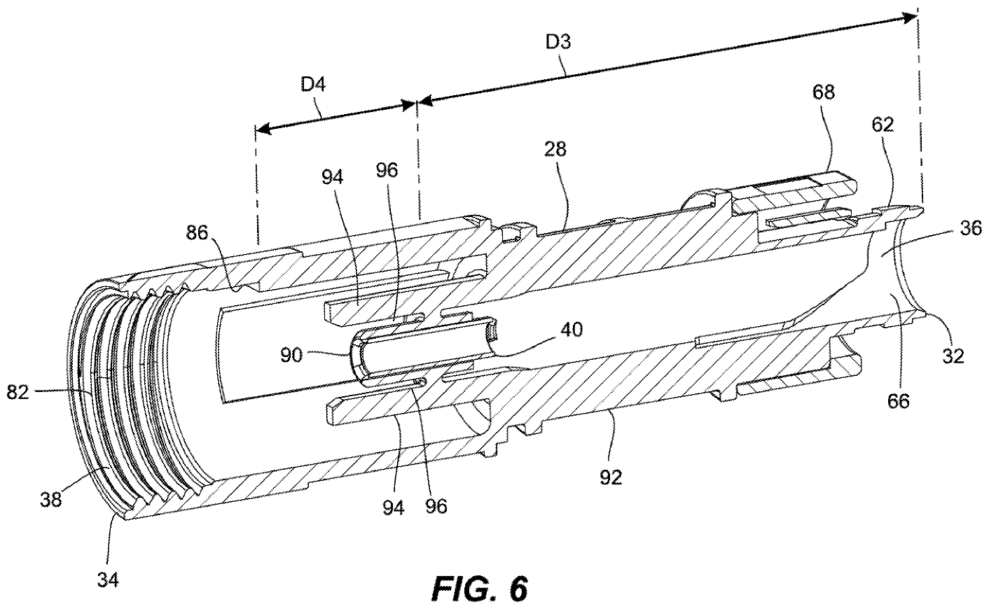

In one example, the inner circumferential sealing surface 86 of the second connector port 38 is substantially closer to the midpoint 46 than the inner circumferential sealing surface 66 of the first connector port 36. Referring to FIG. 6, the converter 26 defines a distance D3 measured along the central axis 30 between the midpoint 46 and the inner circumferential sealing surface 66 and defines a distance D4 measured along the central axis 30 between the midpoint 46 and the inner circumferential sealing surface 86. In certain examples, the distance D3 is at least 10%, 20%, 30%, 40%, 50%, 60%, 70%, 80% or 90% longer than the distance D4. In one example, the inner circumferential sealing surface 86 of the second connector port 38 is positioned closer to the ferrule alignment sleeve 40 than the connector interlock structure (e.g., the inner threads 82) of the second connector port 38; and the inner circumferential sealing surface 66 of the first connector port 36 is positioned further from the ferrule alignment sleeve 40 than the connector interlock structure (e.g., the outer interlock projections 62) corresponding to the first connector port 36.

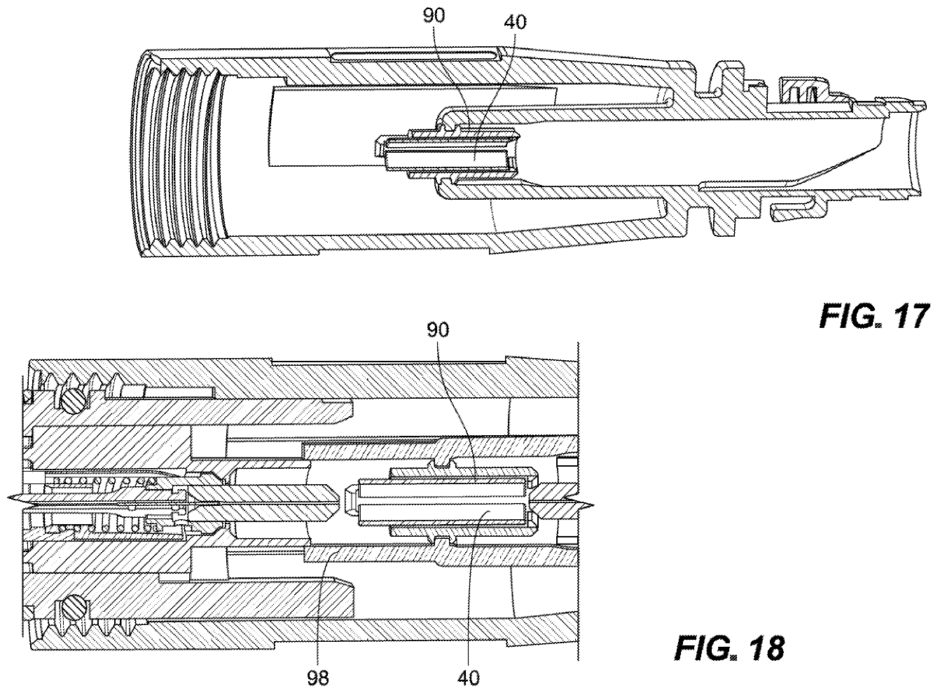

It will be appreciated that the ferrule alignment sleeve 40 can be positioned within the converter housing 28 by an alignment sleeve holder 90. In the example of FIG. 6, the alignment sleeve holder 90 is unitarily formed with the converter housing 28. For example, still referring to FIG. 6, the converter housing 28 includes a one-piece main body 92 that extends fully between the first and second ends 32, 34 of the converter housing 28, that defines the inner threads 82 of the second connector port 38 and the outer interlock projections 62 of the first connector port 36, and that also defines the alignment sleeve holder 90. In one example, the alignment sleeve holder 90 can include a latch for retaining the ferrule alignment sleeve 40 within the alignment sleeve holder 90. In one example, the alignment sleeve 40 can be loaded into the alignment sleeve holder 90 by inserting the alignment sleeve through one end of the alignment sleeve holder. As the alignment sleeve 40 is inserted axially into the alignment sleeve holder 90, the latch flexes to accommodate insertion of the alignment sleeve 40 and then resiliently returns to a retaining position in which the latch retains the alignment sleeve 40 within the alignment sleeve holder 90. In alternative examples, the alignment sleeve holder 90 can be molded as a separate piece from the converter housing 28 and can be secured within the converter housing 28 by a mechanical connection (e.g., a snap-fit connection, and interlocks, etc.) or can be adhesively secured within the converter housing 28. FIGS. 17 and 18 show examples in which the alignment sleeve holder 90 is molded as a separate piece from the converter housing and that is secured within the converter housing 28 by a snap-fit connection.

In certain examples, the converter housing 28 can include structure at the second connector port 38 for guiding insertion of the second male fiber optic connector 24 into the second connector port 38 such that the ferrule 44 of the second male fiber optic connector 24 is received within the ferrule alignment sleeve 40. For example, referring to FIG. 6-8, the converter 26 can include guide ribs 94 configured to engage the front portion of the connector body 72 of the second male fiber optic connector 24 as the second male fiber optic connector 24 is inserted into the second connector port 38 to guide insertion of the second male fiber optic connection 24 such that the ferrule 44 is received within the ferrule alignment sleeve 40. In certain examples, the guide ribs 94 are unitarily formed with the converter housing 28. In certain examples, the guide ribs 94 have outer ends that are tapered (e.g. chamfered, angled) to provide tapered lead-in sections for guiding insertion of the second male fiber optic connector 24. In certain examples, the guide ribs 94 are radially spaced from the alignment sleeve holder 90 such that guide slots 96 are defined between the connector guide ribs 94 and the alignment sleeve holder 90. The guide slots 96 are configured to receive the front end portion of the connector body 72 of the second male fiber optic connector 24 when the second male fiber optic connector 24 is inserted into the second connector port 38 (see FIG. 3). In the embodiment of FIG. 18, the converter 26 has been modified to include a guide sleeve 98 for receiving the front portion of the connector body 72 to guide the ferrule 44 into the alignment sleeve 40 during insertion of the second male fiber optic connector 24 into the second connector port 38. The alignment sleeve holder 90 is positioned within the guide sleeve 98 and is inwardly offset from a connector receiving end of the guide sleeve 98.

In certain examples, prior to using the converter 26, the first and second ends 32, 34 of the converter housing 28 can be closed (e.g., blocked, plugged, covered, etc.) by sealing elements adapted to prevent contamination from entering the interior of the converter housing 28. In one example, the second end 34 of the converter housing 28 can be closed by a sealing element such as a plug 110 having exterior threads that are threaded into the inner threads 82 of the second connector port 38 to secure the plug 110 within the second connector port 38. In one example, the plug 110 can include a circumferential seal such as a gasket 112 (e.g., an o-ring) adapted to seal against the inner circumferential sealing surface 86 when the plug 110 is mounted within the second connector port 38. To install the second male fiber optic connector 24 within the second connector port 38, the plug 110 can first be unthreaded from the second connector port 38 thereby allowing the second male fiber optic connector 24 to be inserted therein. In the depicted example, the plug 110 is tethered to the converter housing 28 by a lanyard 114.

In one example, the first end 32 of the converter housing 28 can be covered and sealed by a sealing element such as a plug 120. In a preferred example, the plug 120 can be formed/molded as a single unitary piece and can be constructed of a material having resilient/elastomeric mechanical properties. For example, the single unitary piece can be molded from a material having rubber or rubber-like mechanical properties. In the depicted example, the plug 120 includes an outer gripping portion 122 including a plurality of circumferential ribs 124 that are axially spaced from one another. The plug 120 also includes a plug portion 126 which preferably has an outer diameter that is smaller than an outer diameter of the outer gripping portion 122 and that in certain examples can have a cylindrical shape. The plug portion 126 preferably projects axially outwardly from the outer gripping portion 122. In certain examples, the plug portion 126 can be press fit into the first connector port 36 to seal the first connector port 36. It will be appreciated that the plug portion 126 can be configured to undergo elastomeric deformation as the plug portion is pressed into the first connector port 36. The plug 120 also includes a shroud portion 129 that projects axially from the outer gripping portion 122 and that is radially spaced from the plug portion 126. The shroud portion 129 can be configured to cover and protect the outer interlock projections 62 of the converter 26. It will be appreciated that the plug can also be used to seal ports in other types of optical connection devices such as ports in converters of the type disclosed in PCT international publication numbers WO2020/236512 and WO2021/041305.

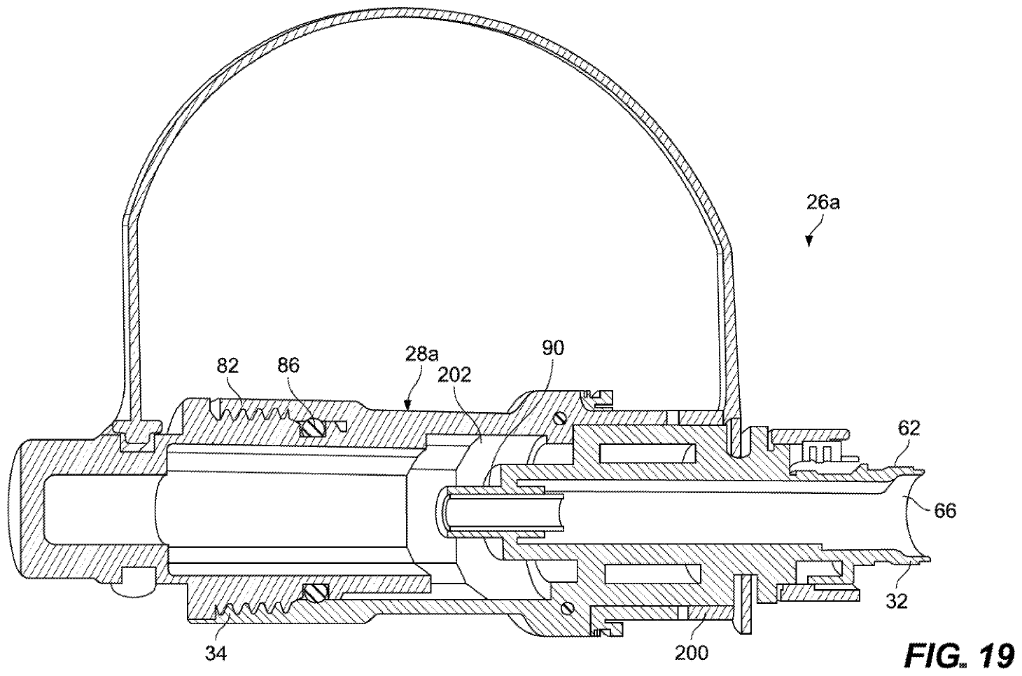

FIG. 19 depicts an alternative converter 26a having a converter housing 28a including first and second converter housing pieces 200, 202 joined together at a sealed interface. In one example, the sealed interface can be sealed by a sealing member (e.g., a gasket such as an o-ring) or can be sealed by a bonding material. In one example, the first and second converter housing pieces 200, 202 can be connected by snap-fit connection. In one example, the first housing piece 200 defines the first end 32 of the converter housing 28a and the second housing piece 202 defines the second end 34 of the converter housing 28a. In one example, the inner threads 82 and the inner circumferential sealing surface 86 of the second connector port 38 are unitarily formed with the second housing piece 202 and the inner circumferential sealing surface 66, the outer interlock projections 62 and the alignment sleeve holder 90 are unitarily formed with the first housing piece 200.

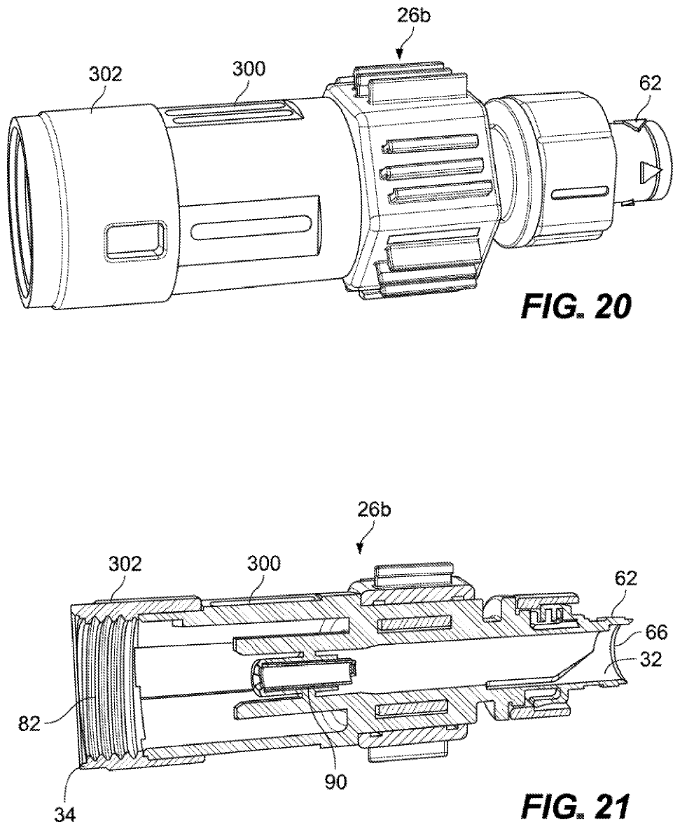

FIGS. 20 and 21 depict another converter 26b having a converter housing 28b including a main housing piece 300 and an end cap 302 joined together at a sealed interface that may be sealed by a sealing member or by bonding material. In one example, the end cap 302 can be attached to the main housing piece 300 by a snap-fit connection. In the depicted example, the end cap 302 defines the inner threads 82 and also defines the second end 34 of the converter housing 28b. The main housing piece 300 defines the first end 32 of the converter housing 28b, the outer interlock projections 62, the inner sealing surface 66, and the alignment sleeve holder 90. The alignment sleeve holder 90 is unitarily formed with the main housing piece 300.

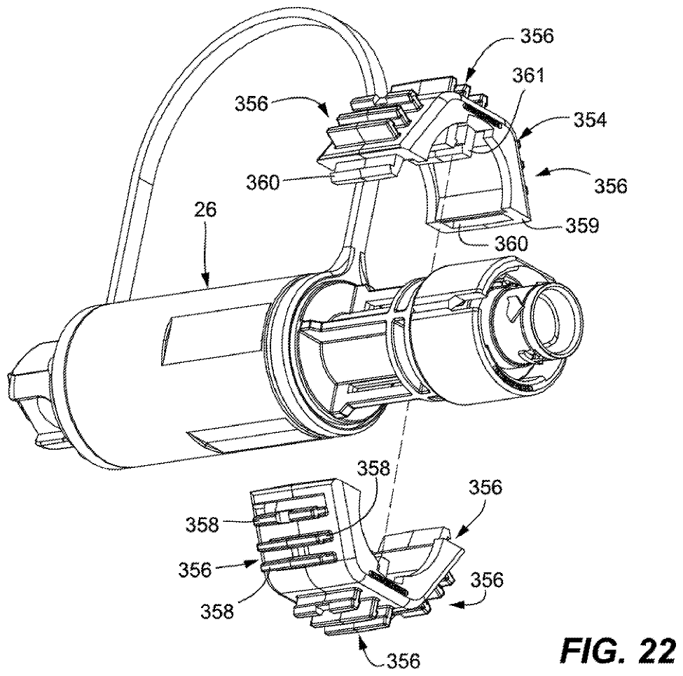

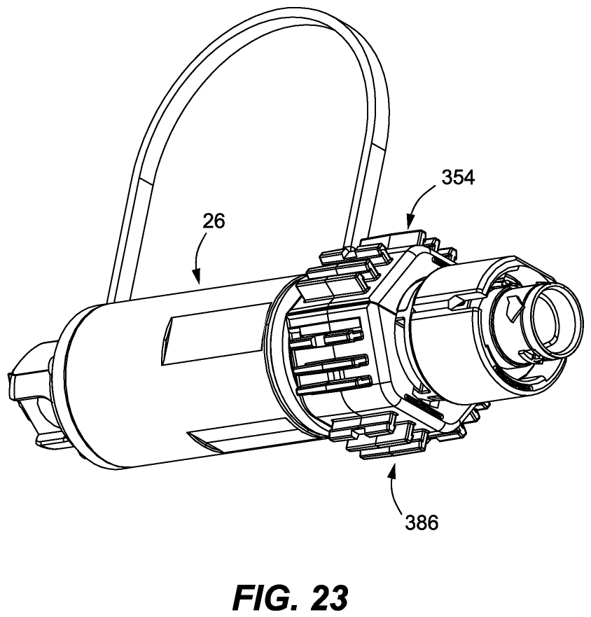

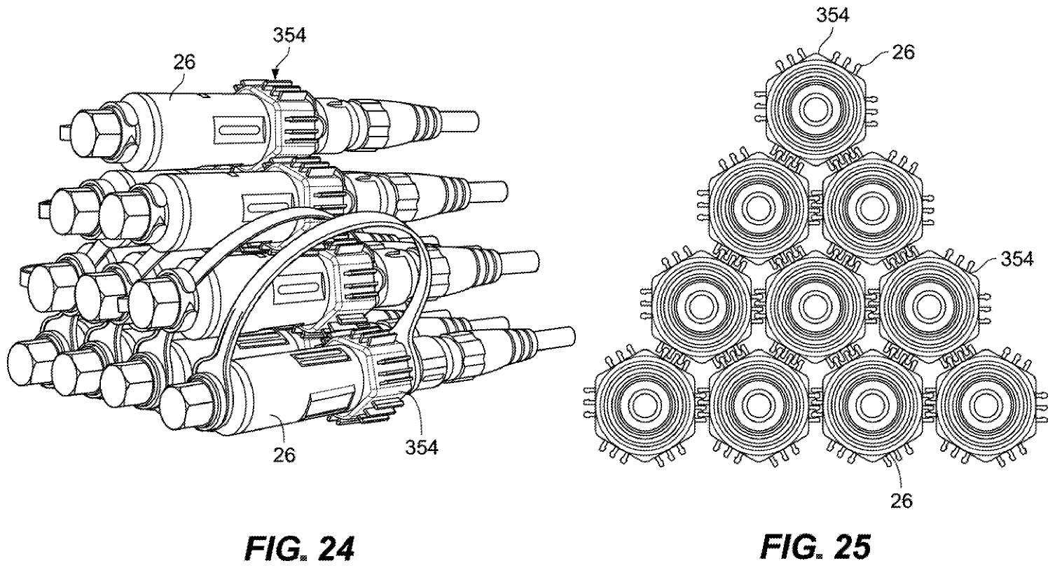

FIGS. 22 and 23 depict the converter 26b in combination with a lateral coupler 354 laterally coupling a plurality of the converters 26 together in a group with central axes of the converters 26 parallel to one another as shown at FIGS. 24 and 25. In the arrangement of FIGS. 24 and 25, the converters 26 are coupled together in a triangular configuration. In certain examples, the converters 26 can be coupled together so as to form at least one row of converters or to form multiple rows of converters. It will be appreciated that lateral couplers in accordance with the principles of the present disclosure can be used to group together any type of fiber-optic connection device such as converters, female connectors and male connectors.

Referring to FIG. 22, the lateral coupler 354 includes a plurality of outwardly facing connection interfaces 356 position circumferentially about the central axis of the converter 26. The connection interfaces 356 can be configured to allow a first one of the converters 26 equipped with one of the lateral couplers 354 to be laterally coupled to a second one of the converters 26 equipped with one of the lateral couplers 354. In certain examples, the connection interfaces 356 can be configured to couple with respect to one another. For example, the connection interfaces 356 can couple via an interlocking connection (e.g., a snap fit connection), a sliding connection, press fit connection or other type of connection. In the depicted example, each of the connection interfaces 356 includes a plurality of parallel latching members 358. When two of the connection interfaces are pressed together, the latching members fit between one another and interlock with one another (e.g., via a snap-fit connection).

In certain examples, the connection interfaces 356 are provided at distinct sides of the lateral coupler 354. In certain examples, the lateral coupler includes at least two, three, four, five or six of the distinct sides with each one of the distinct sides having one of the connection interfaces 356. In the depicted example, the lateral coupler 354 includes two half-pieces 359 that are coupled together about the converter by a snap-fit connection. The snap-fit connection can include a first set of snap-fit connections 360 between the first and second pieces 359 (e.g., half-pieces), and a second set of snap-fit connections 361 between each of the pieces 359 and a corresponding structure provided on the converter housing 28.

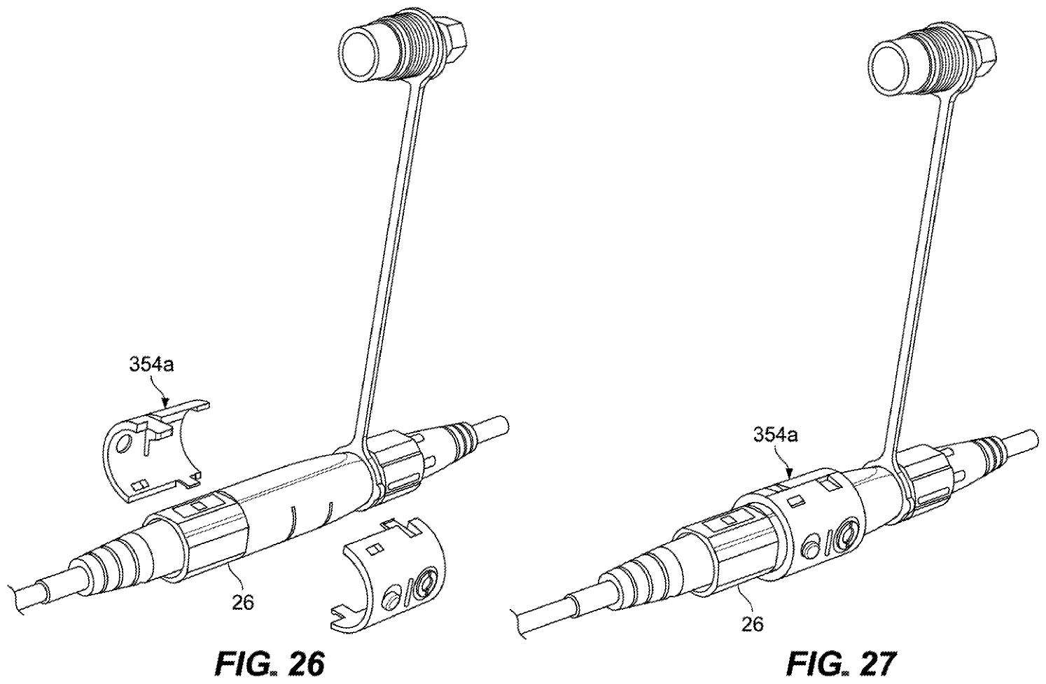

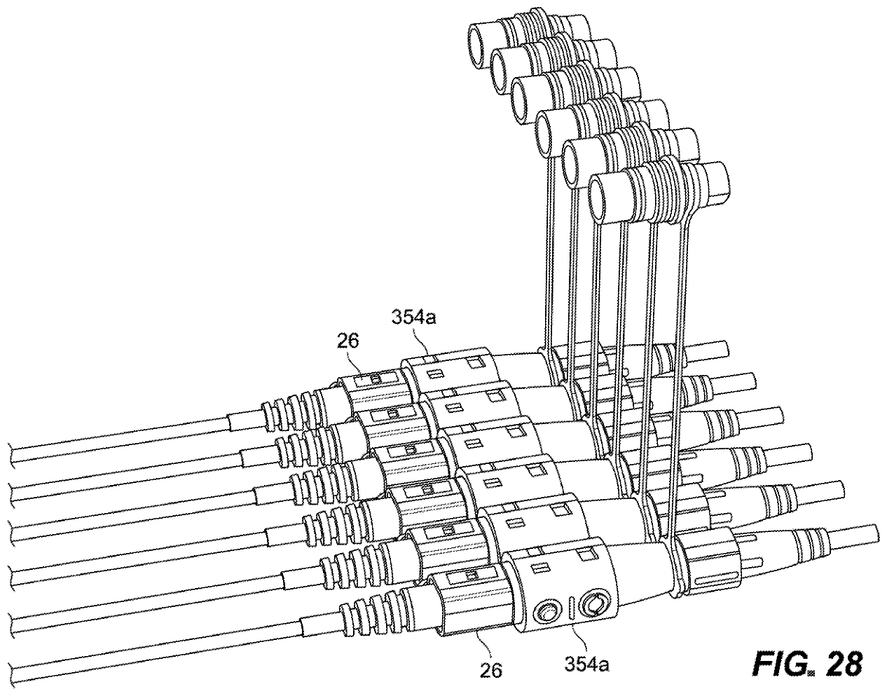

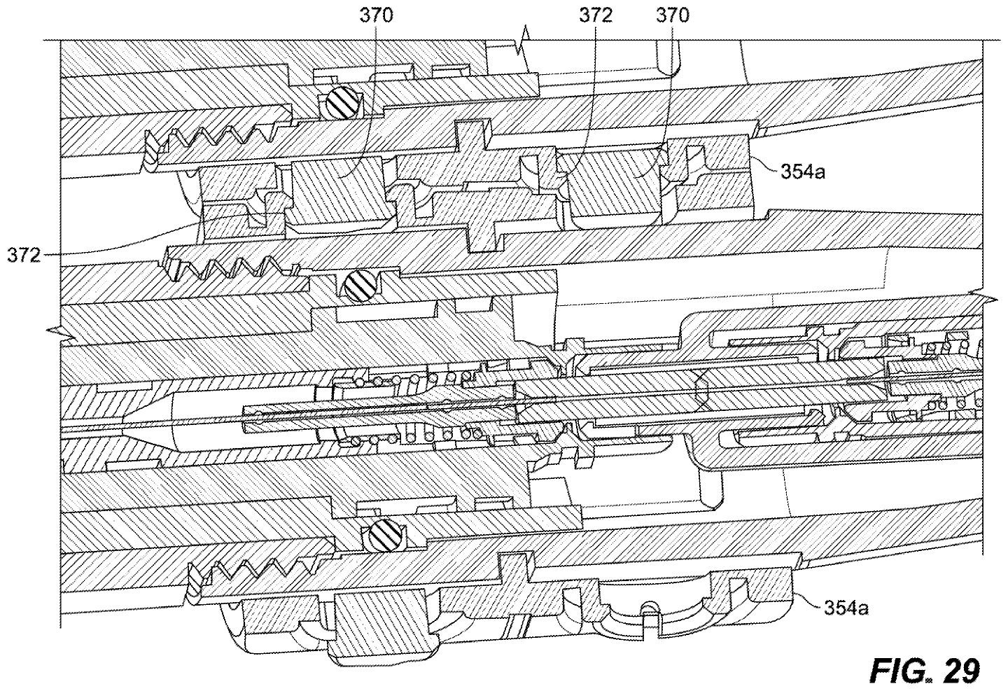

FIGS. 26-29 depict another lateral coupler 354a in accordance with the principles of the present disclosure having alternative connection interfaces 356a each defining a snap-fit configuration. Each of the connection interfaces 356a includes a snap button 370 and a snap button receiver 372. When first and second lateral couplers 354a are coupled together to laterally interlink two of the converters 26, the snap button 370 of the connection interface 356a of the first lateral coupler snaps within the snap button receiver 372 of the second lateral coupler and the snap button 370 of the connection interface 356a of the second lateral coupler snaps within the snap button receiver 372 of the first lateral coupler (see FIG. 29). FIG. 28 shows the converters 26 coupled laterally by the couplers 354a together to form a row of converters.

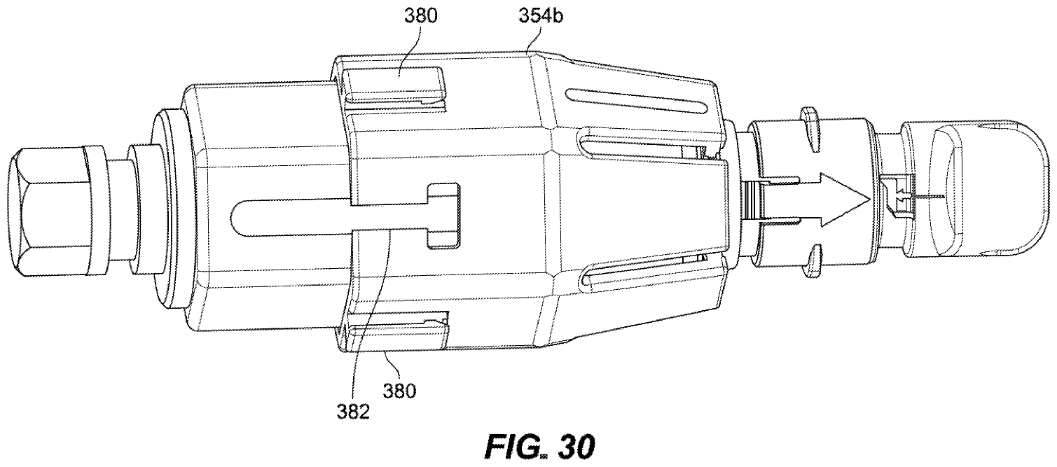

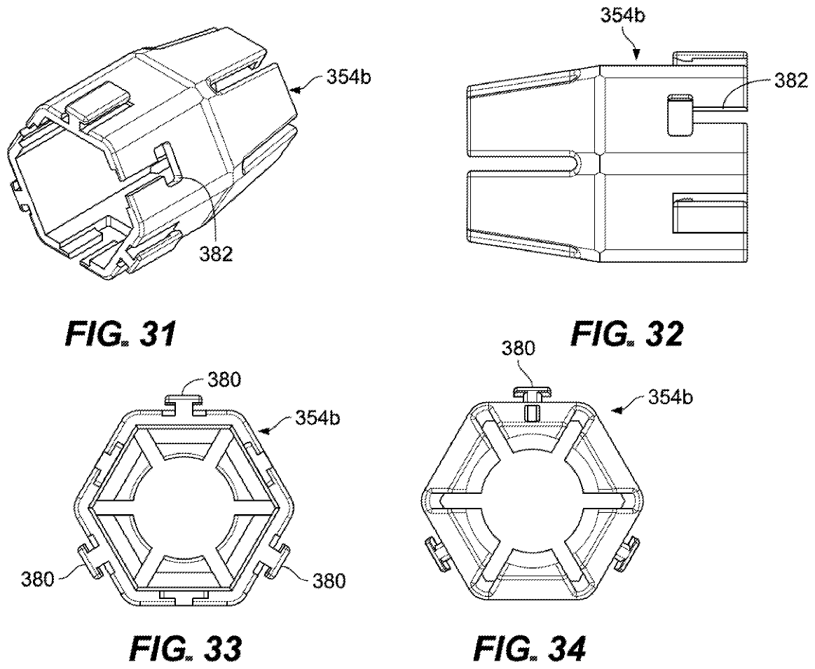

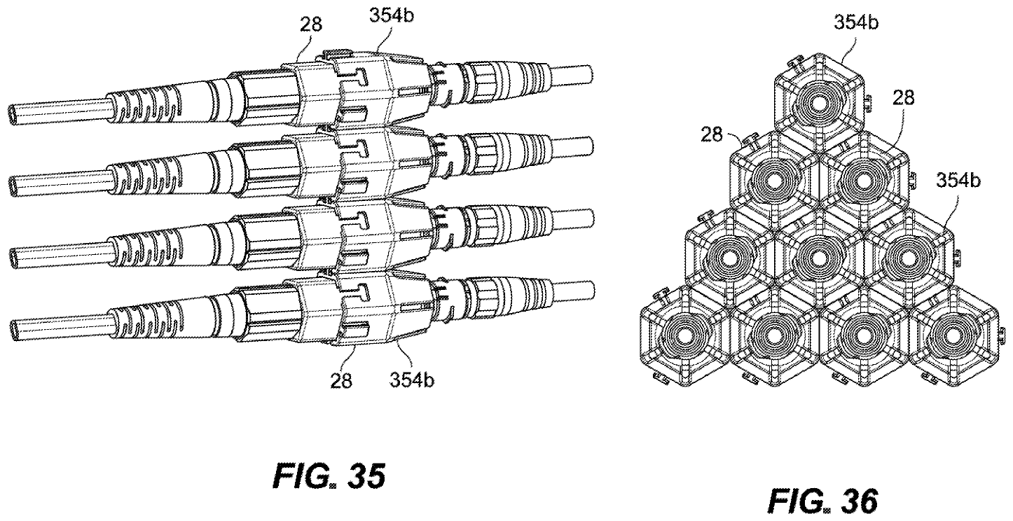

FIGS. 30-36 depict still another lateral coupler 354b in accordance with the principles of the present disclosure having connection interfaces 356b defining tongue-and-groove connections. The lateral coupler 354b as a plurality of discrete sides each alternating really provided with of tongue 380 and groove 382. Two of the lateral couplers 354b are coupled together by engaging one of the tongues 380 of one of the lateral couplers 354b with one of the grooves 382 of an adjacent one of the lateral couplers 354b. The lateral coupler 354b has a one-piece construction and is adapted to be snapped axially over a fiber-optic connection device to provide the fiber-optic connection device with lateral connection interfaces. FIG. 35 shows a plurality of converters equipped with lateral couplers 354b which are coupled together to fix the converters side-by-side in a row. FIG. 36 shows a plurality of converters equipped with lateral couplers 354b which are coupled together to fix the converters side by side in a grouping having multiple rows. For example, as viewed from the ends of the converters as shown in FIG. 36, the converters are arranged in a triangular grouping.

What is claimed is:

1. A converter for converting a first male fiber optic connector to a female fiber optic connector, the converter comprising:
a converter housing having a length that extends along a central axis of the converter housing between first and second opposite ends of the converter housing, the converter housing defining a first connector port at the first end of the converter housing and a second connector port at the second end of the converter housing, the first connector port being smaller than the second connector port and being configured to receive the first male fiber optic connector, the second connector port being configured to receive a second male fiber optic connector desired to be optically coupled to the first male fiber optic connector via the converter; and
a ferrule alignment sleeve positioned within the converter housing along the central axis for aligning ferrules of the first and second male fiber optic connectors, the ferrule alignment sleeve being positioned closer to the second end of the converter housing than the first end of the converter housing.

2. The converter of claim 1, wherein the converter defines a first distance measured along the central axis between the first end of the converter housing and a midpoint of the ferrule alignment sleeve, wherein the converter defines a second distance measured along the central axis between the second end of the converter housing and the midpoint of the ferrule alignment sleeve, and wherein the first distance is at least 10 percent longer than the second distance.

3. The converter of claim 2, wherein the first distance is at least 20, 30, 40, 50, 60, 70, 80 or 90 percent longer than the second distance.

4. The converter of claim 1, wherein the converter includes interlocks compatible with turn-to-secure connection arrangements for securing the first and second male fiber optic connectors within the first and second connector ports, and wherein the converter includes seals for engaging the first and/or second male fiber optic connectors or sealing surfaces adapted to engage seals of the first and/or second male fiber optic connectors to provide sealing between the first and second male fiber optic connectors and the converter housing.

5. The converter of claim 1, wherein the converter is configured such that the first and second male fiber optic connectors are sealed with respect to the converter housing when secured in the first and second connector ports.

6. The converter of claim 4, wherein the interlocks include threads, bayonet connection features, or interlock projections positioned circumferentially about the central axis.

7. The converter of claim 1, wherein the converter housing includes a first inner sealing surface corresponding to the first connector port for engaging a seal of the first male fiber optic connector and a second inner sealing surface corresponding to the second connector port for engaging a seal of the second male fiber optic connector, and wherein the ferrule alignment sleeve is closer to the second inner sealing surface than the first inner sealing surface.

8. The converter of claim 7, wherein the converter defines a first distance measured along the central axis between the first inner sealing surface of the converter housing and a midpoint of the ferrule alignment sleeve, wherein the converter defines a second distance measured along the central axis between the second inner sealing surface of the converter housing and the midpoint of the ferrule alignment sleeve, and wherein the first distance is at least 10 percent longer than the second distance.

9. The converter of claim 8, wherein the first distance is at least 20, 30, 40, 50, 60, 70, 80 or 90 percent longer than the second distance.

10. The converter of claim 4, wherein the interlocks include a first interlock arrangement corresponding to the first connector port for use in securing the first male fiber optic connector within the first connector port and a second interlock arrangement corresponding to the second connector port for use in securing the second male fiber optic connector within the second connector port, wherein the converter housing includes a first inner sealing surface corresponding to the first connector port for engaging a seal of the first male fiber optic connector and a second inner sealing surface corresponding to the second connector port for engaging a seal of the second male fiber optic connector, wherein the first inner sealing surface is positioned further from the ferrule alignment sleeve than the first interlock arrangement, and wherein the second inner sealing surface is positioned closer to the ferrule alignment sleeve than the second interlock arrangement.

11. The converter of claim 10, wherein the second interlock arrangement includes threads defined within the second connector port.

12. The converter of claim 1, wherein the converter housing includes a main body, and wherein an alignment sleeve holder for holding the ferrule alignment sleeve is unitarily formed with the main body.

13. The converter of claim 12, wherein the second connector port includes inner threads for securing the second male fiber optic connector within the second connector port, and wherein the inner threads are unitarily formed with the main body of the converter housing.

14. The converter of claim 12, wherein the second connector port includes inner threads for securing the second male fiber optic connector within the second port, and wherein the inner threads are formed within an end cap mounted to an end of the main body, wherein the end cap defined the second end of the converter housing.

15. The converter of claim 1, wherein the converter housing includes a first housing piece that defines the first connector port and a second housing piece that defines the second connector port, wherein the first and second housing pieces coupled together at a sealed interface, wherein an alignment sleeve holder for holding the ferrule alignment sleeve is unitarily formed with the first housing piece, wherein the second connector port includes inner threads for securing the second male fiber optic connector within the second connector port, and wherein the inner threads are unitarily formed with the second housing piece.

16. The converter of claim 12, wherein the converter includes connector guide ribs unitarily formed with the main body for guiding the second male fiber optic connector within the second connector port such that a ferrule of the second male fiber optic connector is received within the ferrule alignment sleeve.

17. The converter of claim 16, wherein the connector guide ribs have tapered lead-in sections and are radially spaced from the alignment sleeve holder such that guide slots are defined between the connector guide ribs and the alignment sleeve holder, wherein the second male fiber optic connector includes an inner connector body that surrounds a ferrule of the second male fiber optic connector, and wherein the guide slots are configured to receive an end portion of the inner connector body when the second male fiber optic connector is inserted into the second connector port.

18. The converter of claim 1, wherein the converter housing includes a main body, wherein an alignment sleeve holder for holding the ferrule alignment sleeve is unitarily is held within the main body by a snap-fit connection, wherein the second connector port includes inner threads for securing the second male fiber optic connector within the second connector port, and wherein the inner threads are unitarily formed with the main body of the converter housing.

19. The converter of claim 4, wherein the interlocks include a first interlock arrangement corresponding to the first connector port for use in securing the first male fiber optic connector within the first connector port, wherein the converter housing includes a first inner sealing surface corresponding to the first connector port for engaging a radial seal of the first male fiber optic connector, wherein the first inner sealing surface faces radially toward the central axis, wherein the first interlock arrangement includes outer interlock projections positioned circumferentially about the central axis and integrated with an outer side of the converter housing adjacent the first end of the converter housing, the interlock projections being adapted to interlock with projections of a turn-to-secure coupler of the first male fiber optic connector, the turn-to-secure coupler being axially insertable over and axially removeable from the first end of the converter housing without interference from the interlock projections when in a first rotational position, the projections of the turn-to-secure coupler interfering with the interlock projections when the turn-to-secure coupler is in a second rotational position such that axial movement between the turn-to-secure coupler and the first end of the converter housing is prevented, wherein the turn-to-secure coupler is used to secure the first male fiber optic connector to the first end of the converter housing by inserting the turn-to-secure coupler over the first end of the converter housing while the turn-to-secure coupler is in the first rotational position and then turning the turn-to-secure coupler from the first rotational position the second rotational position once the turn-to-secure coupler has been inserted over the first end of the converter housing to axially secure the turn-to-secure coupler on the first end of the converter housing, wherein the converter includes a latch that locks the turn-to-secure coupler in the second rotational position on the first end of the converter housing, and wherein the converter includes an outer sleeve for covering the latch to block access to the latch, wherein the latch can only be unlatched by breaking the sleeve to remove the sleeve from the converter housing.

20. The converter of claim 19, wherein the latch is unitarily formed with the sleeve.

21. The converter of claim 4, wherein the interlocks include a first interlock arrangement corresponding to the first connector port for use in securing the first male fiber optic connector within the first connector port, wherein the converter housing includes a first inner sealing surface corresponding to the first connector port for engaging a radial seal of the first male fiber optic connector, wherein the first inner sealing surface faces radially toward the central axis, wherein the first interlock arrangement includes outer interlock projections positioned circumferentially about the central axis and integrated with an outer side of the converter housing adjacent the first end of the converter housing, the interlock projections being adapted to interlock with projections of a turn-to-secure coupler of the first male fiber optic connector, the turn-to-secure coupler being axially insertable over and axially removeable from the first end of the converter housing without interference from the interlock projections when in a first rotational position, the projections of the turn-to-secure coupler being configured to interfere with the interlock projections when the turn-to-secure coupler is in a second rotational position such that axial movement between the turn-to-secure coupler and the first end of the converter housing is prevented, wherein the turn-to-secure coupler is used to secure the first male fiber optic connector to the first end of the converter housing by inserting the turn-to-secure coupler over the first end of the converter housing while the turn-to-secure coupler is in the first rotational position and then turning the turn-to-secure coupler from the first rotational position the second rotational position once the turn-to-secure coupler has been inserted over the first end of the converter housing to axially secure the turn-to-secure coupler on the first end of the converter housing, wherein the converter housing includes an outer circumferential reinforcing rib positioned between the outer interlock projections and the first end of the converter housing, the outer circumferential reinforcing rib surrounding the first inner sealing surface.

22. The converter of claim 1, further comprising a lateral coupler that mounts on the converter housing for laterally coupling a plurality of the converters together in a group with the central axes of the converters parallel to one another.

23. The converter of claim 22, wherein the lateral coupler includes a plurality of outwardly facing connection interfaces positioned circumferentially about the central axis.

24. The converter of claim 23, wherein the connection interfaces are provided at distinct sides of the lateral coupler.

25. The converter of claim 24, wherein the lateral coupler includes at least 3, 4, 5 or 6 of the distinct sides each having one of the connection interfaces.

26. The converter of claim 25, wherein the lateral coupler includes two pieces that are coupled together about the converter housing by a snap-fit connection.

27. The converter of claim 1, further comprising a first plug having a resilient construction adapted to be press fit within the first connector port when the first male fiber optic connector is not inserted in the first connector port, and a second plug attached to the converter housing by a lanyard and adapted to be secured within the second connector port by a turn-to-secure connection when the second male fiber optic connector is not inserted in the second connector port.

28. A fiber optic device comprising:
a fiber optic connection device; and
a lateral coupler that mounts on the fiber optic connection device for laterally coupling a plurality of the fiber optic connection devices together in a group with central axes of the fiber optic connection devices parallel to one another.

29. The converter of claim 28, wherein the lateral coupler includes a plurality of outwardly facing connection interfaces positioned circumferentially about the central axis of the fiber optic connection device.

30. The converter of claim 29, wherein the connection interfaces are provided at distinct sides of the lateral coupler.

31. The converter of claim 30, wherein the lateral coupler includes at least 2, 3, 4, 5 or 6 of the distinct sides each having one of the connection interfaces.

32. The converter of claim 31, wherein the lateral coupler includes two pieces that are coupled together about the converter housing by a snap-fit connection.

33. A converter for converting a first male fiber optic connector to a female fiber optic connector, the converter comprising:
a converter housing having a length that extends along a central axis of the converter housing between first and second opposite ends of the converter housing, the converter housing defining a first connector port at the first end of the converter housing and a second connector port at the second end of the converter housing, the second connector port being configured to receive a second male fiber optic connector desired to be optically coupled to the first male fiber optic connector via the converter; and
a first plug having a resilient construction adapted to be press fit within the first connector port when the first male fiber optic connector is not inserted in the first connector port, and a second plug attached to the converter housing by a lanyard and adapted to be secured within the second connector port by a turn-to-secure connection when the second male fiber optic connector is not inserted in the second connector port.

34. A converter for coupling a first male fiber optic connector to another optical component, the converter comprising:
a converter housing having a length that extends along a central axis of the converter housing between first and second opposite ends of the converter housing, the converter housing defining a first connector port at the first end of the converter housing, the first connector port being configured to receive the first male fiber optic connector, the second end of the converter housing being configured to interface with the optical component; and
a first sealing element having a resilient construction adapted to be press fit within the first connector port when the first male fiber optic connector is not inserted in the first connector port to prevent contamination from entering the converter housing through the first connector port, and a second sealing element attached to the converter housing by a lanyard and adapted to be secured at the second end of the converter housing by a turn-to-secure connection when the second end of the converter housing is not mated with the optical component to prevent contamination from entering the converter housing through the second end of the converter housing.
